(19) United States
(12) Patent Application Publication
(10) Pub. No.: US 2016/0114711 A1
(43) Pub. Date: Apr. 28, 2016

(54) VEHICLE SEAT

(71) Applicant: TOYOTA JIDOSHA KABUSHIKI KAISHA, Toyota-shi (JP)

(72) Inventor: Gen TAKAHASHI, Nagakute-shi (JP)

(21) Appl. No.: 14/857,101

(22) Filed: Sep. 17, 2015

(30) Foreign Application Priority Data
Oct. 24, 2014 (JP) 2014-217647

(51) Int. Cl. B60N 2/68; B60N 2/70

(52) U.S. Cl. CPC B60N 2/68; B60N 2/70

(57) ABSTRACT

A vehicle seat of the present invention includes: a seat cushion frame that supports the buttocks and thighs of a seated occupant; a cloth-form member that is attached to the seat cushion frame, that extends along a seat front-rear direction and a seat width direction, that has stretch properties, and that supports a load of the seated occupant; and an elongated member that is fixed at a lower face side of, or inside, a seat front-rear direction intermediate portion of the cloth-form member, and that is formed in an elongated shape with its length direction along the seat width direction.

### CROSS-REFERENCE TO RELATED APPLICATION

This application claims priority under 35 USC 119 from Japanese Patent application No. 2014-217647 filed on Oct. 24, 2014, the disclosure of which is incorporated by reference herein.

### BACKGROUND

1. Technical Field

The present invention relates to a vehicle seat.

2. Related Art

Japanese Patent Application Laid-Open (JP-A) No. 2014-136472 describes a vehicle seat capable of supporting load of a seated occupant in a desirable manner. To briefly explain the technology described in the Patent Document, a seat cushion of a vehicle seat includes a cushion frame formed in a frame shape, and a flexible cloth spring bridging across the cushion frame. The cloth spring formed in cloth-form supports load of the seated occupant, such that the load of the seated occupant can be supported over a wider surface area.

Although the technology described in JP-A No. 2014-136472 above is useful from the perspective of supporting load of a seated occupant over a wider surface area, there is room for improvement from the perspective of improving hold performance to tilting of the seated occupant in the seat width direction.

### SUMMARY

In consideration of the above circumstances, the present invention provides a vehicle seat capable of improving hold performance with respect to a seated occupant tilting in the seat width direction.

A vehicle seat of a first aspect of the present invention includes: a seat cushion frame that supports the buttocks and thighs of a seated occupant; a cloth-form member that is attached to the seat cushion frame, that extends along a seat front-rear direction and a seat width direction, that has stretch properties, and that supports a load of the seated occupant; and an elongated member that is fixed at a lower face side of, or inside, a seat front-rear direction intermediate portion of the cloth-form member, and that is formed in an elongated shape with its length direction along the seat width direction.

In the first aspect, load of the seated occupant is supported by the cloth-form member attached to the seat cushion frame. In the present invention, the rigidity at a location where the elongated member is fixed to the cloth-form member is higher than the rigidity at locations where the elongated member is not fixed to the cloth-form member. Namely, the location where the elongated member is fixed to the cloth-form member is thereby less liable to undergo stretching deformation. Thus the location where the elongated member is attached to the cloth-form member is suppressed from undergoing stretching deformation in the seat width direction when the seated occupant tilts in the seat width direction. This enables hold performance with respect to a seated occupant tilting in the seat width direction to be improved.

A vehicle seat of a second aspect of the present invention is the first aspect, wherein a pair of elongated members are respectively disposed at the cloth-formed member, at a seat front side and a seat rear side of hip points of the seated occupant.

In the second aspect, the pair of elongated member are disposed at the positions described above with respect to the hip points of the seated occupant. This enables hold performance to tilting of the seated occupant in the seat width direction to be improved, while suppressing the seated occupant from feeling any hardness in the seat cushion. Namely, this enables a reduction in ride comfort to be suppressed, while improving hold performance with respect to a seated occupant tilting in the seat width direction.

A vehicle seat of a third aspect of the present invention is the first aspect, wherein a stretch ratio of the cloth-form member in the seat front-rear direction is set higher than a stretch ratio of the cloth-form member in the seat width direction.

In the third aspect, setting the stretch ratio of the cloth-form member as described above enables hold performance with respect to a seated occupant tilting in the seat width direction to be still further improved.

### BRIEF DESCRIPTION OF THE DRAWINGS

Exemplary embodiments of the present invention will be described in detail based in the following figures, wherein:

FIG. 1 is a perspective view illustrating a seat cushion of a vehicle seat according to a first exemplary embodiment, viewed obliquely from the seat front side;

FIG. 2 is a perspective view corresponding to FIG. 1, illustrating a seat cushion of a vehicle seat according to a second exemplary embodiment, viewed obliquely from the seat front side;

FIG. 3 is a side cross-section view illustrating the seat cushion illustrated in FIG. 2, cut away along line 3-3;

FIG. 4 is a side cross-section view corresponding to FIG. 3, illustrating a seat cushion of a vehicle seat according to a third exemplary embodiment; and

FIG. 5 is a perspective view corresponding to FIG. 1, illustrating a seat cushion of a vehicle seat according to a fourth exemplary embodiment, viewed obliquely from the seat front side.

### DETAILED DESCRIPTION

### Vehicle Seat According to First Exemplary Embodiment

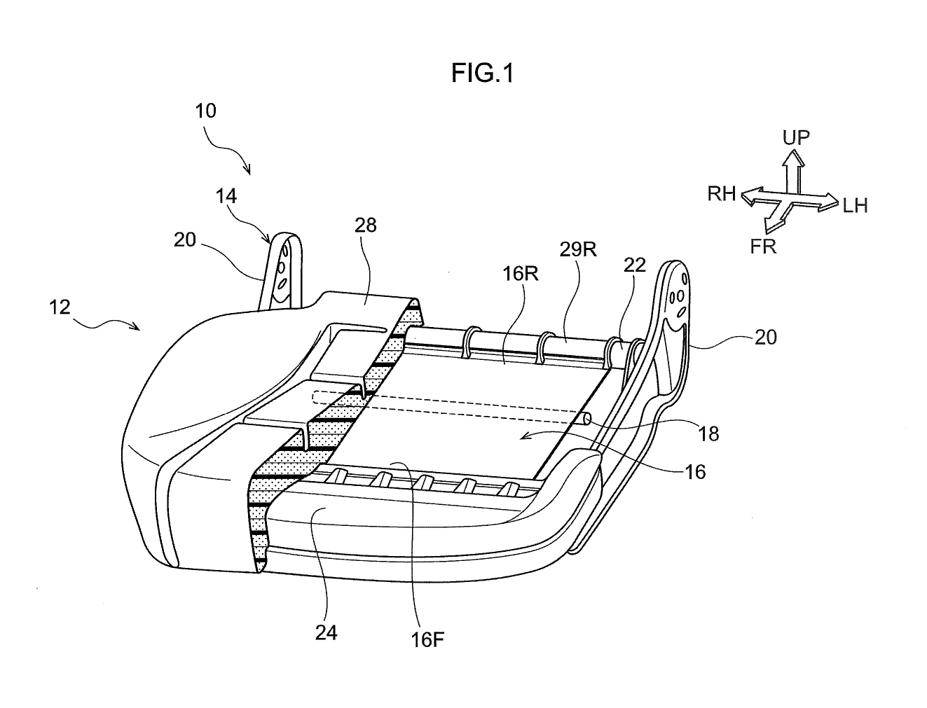

Explanation follows regarding a vehicle seat according to a first exemplary embodiment of the present invention, with reference to FIG. 1. Note that in the following explanation, explanation referring to the front-rear, left-right and up-down directions refers to the front-rear, left-right and up-down directions viewed by an occupant seated in the vehicle seat. Moreover, in each of the drawings, the arrow FR indicates the seat front direction, the arrow UP indicates the seat upward direction, the arrow RH indicates the seat right direction, and the arrow LH indicates the seat left direction, as appropriate.

As illustrated in FIG. 1, a vehicle seat 10 of the present exemplary embodiment is configured including a seat cushion 12 that supports the buttocks and thighs of a seated occupant, and a seatback, not illustrated in the drawings, that supports the back of the seated occupant and that is attached to a rear end section of the seat cushion 12 so as to be capable of reclining.

The seat cushion 12 includes a seat cushion frame 14 forming a frame of the seat cushion 12, a cloth spring 16 serving as a cloth-form member attached to the seat cushion frame 14, and a stabilizer bar 18 serving as an elongated member fixed to the cloth spring 16.

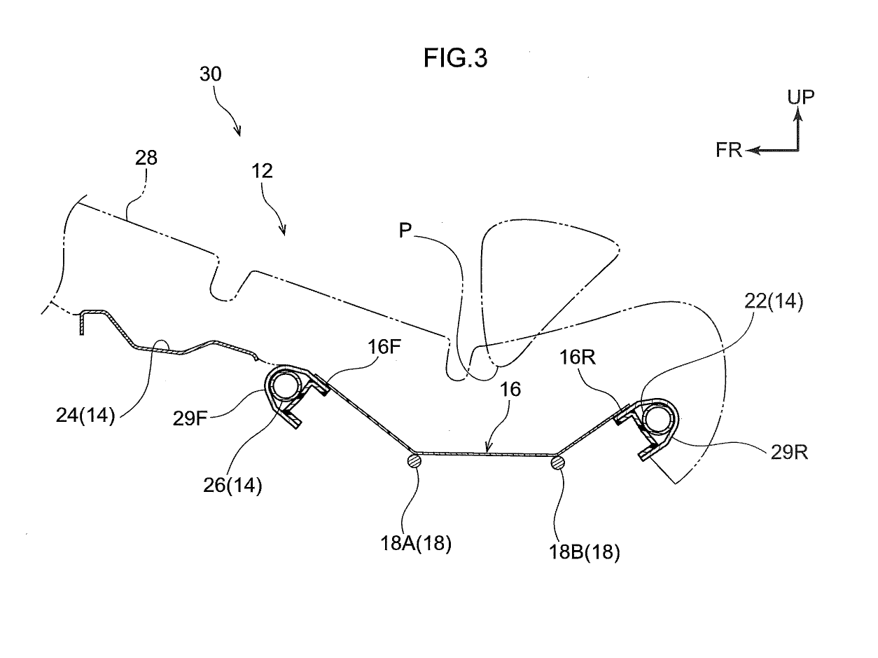

The seat cushion frame 14 is formed in a rectangular shape in a seat plan view. The seat cushion frame 14 includes a pair of side frames 20 extending along the seat front-rear direction and disposed with an interval along the seat width direction therebetween, and a rear frame 22 linking together seat rear side end portions of the pair of side frames 20 along the seat width direction. The seat cushion frame 14 also includes a front panel frame 24 linking together seat front side end portions of the pair of side frames 20 along the seat width direction, and a front frame 26 linking together the pair of side frames 20 along the seat width direction at the side of a seat rear side end portion of the front panel frame 24 (see FIG. 3). A seat cushion pad 28, covered by a cover member, is attached to the seat cushion frame 14 described above.

The cloth spring 16 is formed in a rectangular shaped cloth-form extending along the seat front-rear direction and the seat width direction at the seat lower side of the seat cushion 12. The cloth spring 16 is a stretch-woven fabric formed by intersecting and weaving resilient threads extending along the seat front to rear and non-resilient threads extending along the seat width direction. A material that has excellent stretch and recovery properties, such as thermoplastic elastomer, examples of which include a polyester-based elastomer, a polysulfide-based elastomer, or a polyurethane-based elastomer, is employed for the resilient threads. A material other than a resilient thread, such as a thread formed of polyethylene terephthalate, polybutylene terephthalate, polyethylene terephthalate, or a copolymer thereof, polyamide, or metallic fibers may be employed as the non-resilient threads. Since the cloth spring 16 is formed using the resilient threads and the non-resilient threads as described above, the stretch ratio of the cloth spring 16 along the seat front-rear direction is higher than the stretch ratio along the seat width direction. A seat front side end portion 16F and a seat rear side end portion 16R of the cloth spring 16 described above are fixed to the front frame 26 (see FIG. 3) and the rear frame 22 by respective brackets 29F, 29R (see FIG. 3).

The stabilizer bar 18 is formed in an elongated shape with its length direction along the seat width direction using a steel member or the like, and the stabilizer bar 18 extends in a straight line in a seat front view. The axial length of the stabilizer bar 18 is set longer than a width direction dimension of the cloth spring 16. The stabilizer bar 18 is fixed to a seat front-rear direction intermediate portion of the cloth spring 16. Note that the stabilizer bar 18 may be fixed to the cloth spring 16 by weaving the stabilizer bar 18 into the cloth spring 16. The stabilizer bar 18 may be fixed to the cloth spring 16 using an adhesive or a fixing member. A portion of the stabilizer bar 18 may be bent, or the axial length of the stabilizer bar 18 may be set shorter than the width direction dimension of the cloth spring 16.

### Operation and Advantageous Effects

Explanation follows regarding operation and advantageous effects of the present exemplary embodiment.

In the vehicle seat 10 of the present exemplary embodiment, the load of a seated occupant is supported by the cloth spring 16 attached to the seat cushion frame 14. In the present exemplary embodiment, the rigidity at a location where the stabilizer bar 18 is fixed to the cloth spring 16 is higher than the rigidity at locations where the stabilizer bar 18 is not fixed to the cloth spring 16. The location of the cloth spring 16 where the stabilizer bar 18 is fixed is thereby less liable to undergo stretching deformation. Thus the location where the stabilizer bar 18 is attached to the cloth spring 16 is suppressed from undergoing stretching deformation in the seat width direction when the seated occupant tilts in the seat width direction, such that a portion of the cloth spring 16 is suppressed from undergoing flexing deformation into a recessed shape. This enables holding performance to tilting of a seated occupant in the seat width direction to be improved.

In the present exemplary embodiment, the stretch ratio of the cloth spring 16 along the seat front-rear direction is set higher than the stretch ratio along the seat width direction. This enables holding performance with respect to a seated occupant tilting in the seat width direction to be further improved.

### Vehicle Seat According to Second Exemplary Embodiment

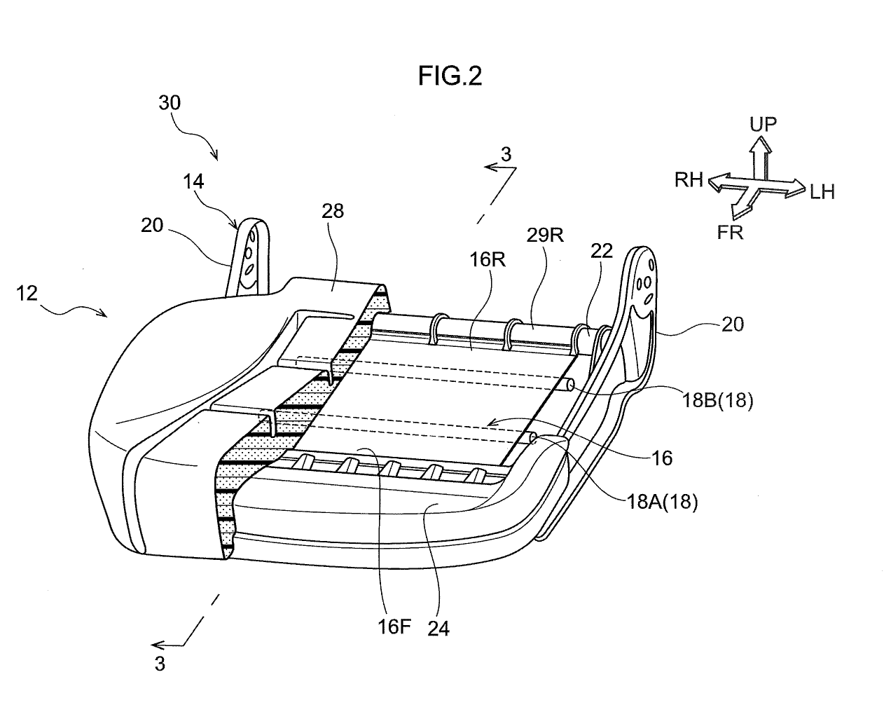

Explanation follows regarding a vehicle seat according to a second exemplary embodiment of the present invention, with reference to FIG. 2 and FIG. 3. Note that members and portions that have similar functions to those in the first exemplary embodiment are appended with the same reference numerals to the above exemplary embodiment, and explanation thereof is omitted.

As illustrated in FIG. 2, a feature of a vehicle seat 30 of the present exemplary embodiment is that a pair of stabilizer bars 18 are fixed to the cloth spring 16 in a state disposed with an interval along the seat front-rear direction. Specifically, as illustrated in FIG. 3, in seat side view, one stabilizer bar 18A (18) is disposed at the seat front side of hip points P of the seated occupant, and the other stabilizer bar 18B (18) is disposed at the seat rear side of the hip points P of the seated occupant. Note that the build of the seated occupant is the same build as an AM50 dummy, and the seated occupant is seated in a standard posture in the vehicle seat 30 set to a standard usage state. The hip points P are points on the vehicle seat 30 set according to an appropriate seated position for a seated occupant.

In the vehicle seat 30 of the present exemplary embodiment as described above, the pair of stabilizer bars 18A, 18B (18) are disposed in the above positions with respect to the hip points P of the seated occupant. This enables holding performance to tilting of the seated occupant in the seat width direction to be improved, while suppressing the seated occupant from feeling any hardness in the seat cushion 12.

### Vehicle Seat According to Third Exemplary Embodiment

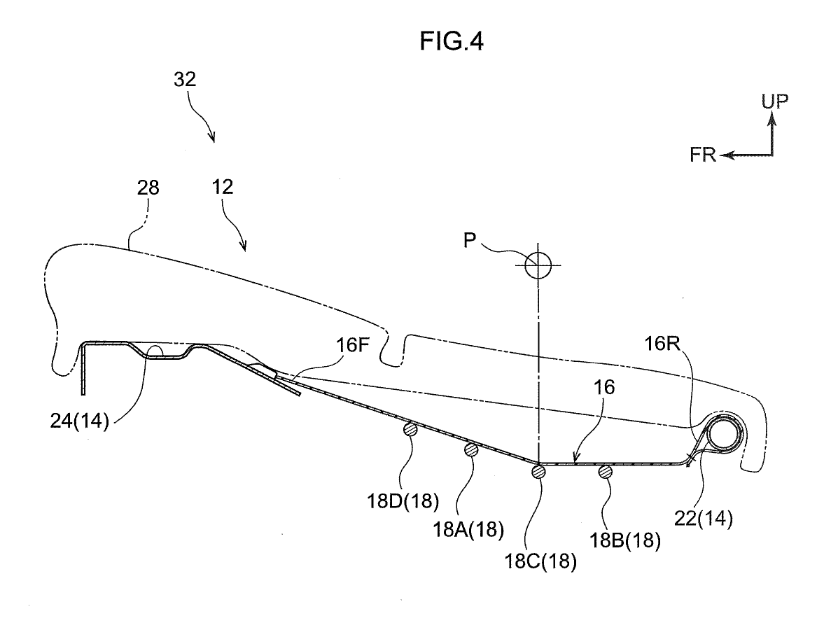

Explanation follows regarding a vehicle seat according to a third exemplary embodiment of the present invention, with reference to FIG. 4. Note that members and portions that have similar functions to those in the first exemplary embodiment and the second exemplary embodiment are appended with the same reference numerals to the above exemplary embodiments, and explanation thereof is omitted.

As illustrated in FIG. 4, a feature of a vehicle seat 32 of the present exemplary embodiment is that four stabilizer bars 18 are fixed to the cloth spring 16 in a state disposed with intervals along the seat front-rear direction. Specifically, as illustrated in FIG. 4, the first stabilizer bar 18A (18) and the second stabilizer bar 18B (18) are disposed in the same positions to those in the second exemplary embodiment. A third stabilizer bar 18C (18) is disposed at the seat lower side of the positions of the hip points of the seated occupant. A fourth stabilizer bar 18D (18) is disposed at the seat front side of the first stabilizer bar 18A (18). Note that in the present exemplary embodiment, the seat front side end portion 16F of the cloth spring 16 is fixed to the front panel frame 24.

In the present exemplary embodiment explained above, the third stabilizer bar 18C (18) is disposed at the seat lower side of the hip points P of the seated occupant, and the fourth stabilizer bar 18D (18) is disposed at the seat front side of the first stabilizer bar 18A (18), thereby enabling holding performance to tilting of the seated occupant in the seat width direction to be still further improved. The vehicle seat 32 may be suitably employed in a sports car or a racing car.

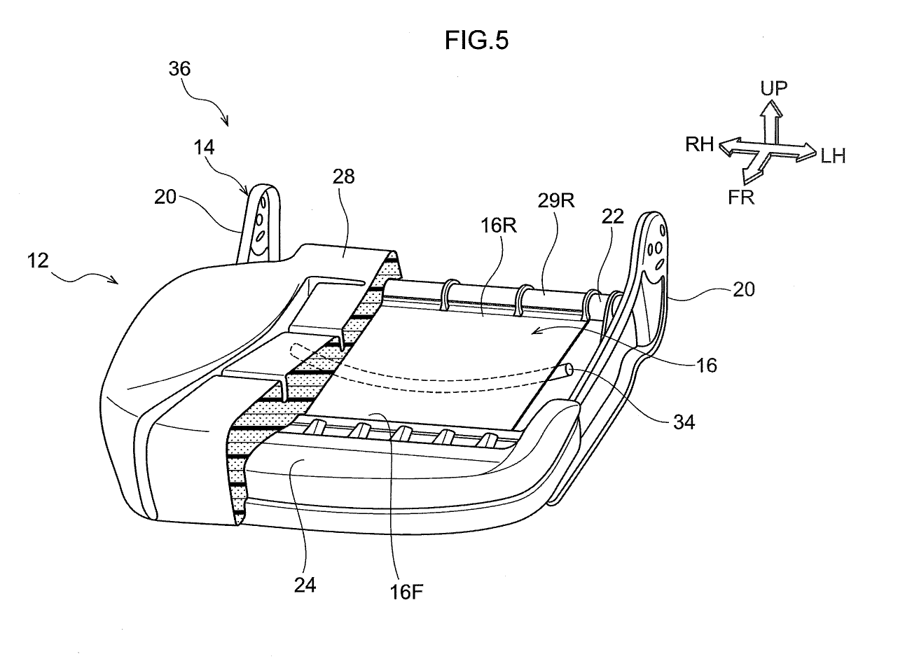

In the first exemplary embodiment to the third exemplary embodiment above, examples have been explained that employ the stabilizer bar(s) 18 formed in a straight line in seat front view; however the present invention is not limited thereto. As illustrated in FIG. 5, for example, a vehicle seat 36 may configured employing a stabilizer bar 34 curved in a substantially U-shape open toward the seat upper side in seat front view.

Although exemplary embodiments of the present invention have been explained above, the present invention is not limited thereto, and obviously various other modifications may be implemented within a range not departing from the spirit of the present invention.

What is claimed is:

1. A vehicle seat comprising:
a seat cushion frame that supports the buttocks and thighs of a seated occupant;
a cloth-form member that is attached to the seat cushion frame, that extends along a seat front-rear direction and a seat width direction, that has stretch properties, and that supports a load of the seated occupant; and
an elongated member that is fixed at a lower face side of, or inside, a seat front-rear direction intermediate portion of the cloth-form member, and that is formed in an elongated shape with its length direction along the seat width direction.

2. The vehicle seat of claim 1, wherein a pair of elongated members are respectively disposed at the cloth-formed member, at a seat front side and a seat rear side of hip points of the seated occupant.

3. The vehicle seat of claim 1, wherein a stretch ratio of the cloth-form member in the seat front-rear direction is set higher than a stretch ratio of the cloth-form member in the seat width direction.
